(19) United States
(12) Patent Application Publication
(10) Pub. No.: US 2005/0035991 A1
(43) Pub. Date: Feb. 17, 2005

(54) Inkjet printer cleaning system and method

(76) Inventor: Daniel John Fredrickson, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/640,661

(22) Filed: Aug. 12, 2003

(51) Int. Cl. B41J 2/165

(52) U.S. Cl. 347/33

(57) ABSTRACT

An inkjet orifice plate cleaning system includes a first wiper configured to engage the inkjet orifice plate at a first speed and a second wiper configured to engage the inkjet orifice plate at a second speed, the first speed being different from the second speed.

### BACKGROUND

Inkjet printing cartridges include a plurality of orifices ejecting ink droplets therefrom. In some configurations, the cartridge reciprocates relative to media and along a scanning axis while ejecting ink droplets according to a given pattern to produce print imaging on the media. Some ink residue can accumulate on an orifice plate of the cartridge affect print quality. Accordingly, the orifice plate occasionally needs cleaning to maintain good print quality. Inkjet printers incorporate cleaning stations for intermittent, including automatic and user initiated, cleaning of printing cartridges. Thus, a problem to be addressed in such systems is efficient and effective cleaning of the orifice plate.

### BRIEF DESCRIPTION OF THE DRAWINGS

For a better understanding of embodiments of the invention, and to show how the same may be carried into effect, reference will now be made, by way of example, to the accompanying drawings in which:

FIG. 1 illustrates schematically a first cleaning system having a wiper pair and an inkjet orifice plate with leading and trailing members of the wiper pair traveling at different speeds relative to the orifice plate.

FIG. 2 illustrates schematically the inkjet cartridge of FIG. 1 as taken along lines 2-2 of FIG. 1 and, in face view, an orifice plate thereof.

FIGS. 3 and 4 illustrate schematically a second cleaning system having a wiper pair engaging an inkjet orifice plate bi-directionally with leading and trailing members of the wiper pair traveling at different speeds relative to the orifice plate.

FIGS. 5-7 illustrate schematically a third cleaning system applying rotary or angular wiper pair movement.

FIGS. 8-10 illustrate schematically a fourth cleaning system applying linear wiper pair movement.

FIG. 11 illustrates a first control algorithm applicable to various embodiments illustrated herein.

FIG. 12 illustrates a second control algorithm applicable to various embodiments illustrated herein.

FIG. 13 illustrates in perspective and schematically a fifth cleaning system.

FIG. 14 illustrates in side view the cleaning system of FIG. 13.

FIG. 15 illustrates in end view the cleaning system of FIGS. 13 and 14.

FIG. 16 illustrates in cross section the cleaning system of FIGS. 13-15.

### DETAILED DESCRIPTION

Orifice plate cleaning can be accomplished by use of a wiper pair moving relative to the orifice plate and engaging the orifice plate to wipe clean the ink ejecting orifices. Generally, a leading wiper, first to engage the orifice plate, draws or wicks ink out of the orifice plate by capillary action. Freshly-drawn ink can act as a solvent to break up and support cleaning action at the orifice plate. A trailing wiper, second to engage the orifice plate, acts as a squeegee to wipe clean the orifice plate. A wiper pair provides wicking action followed by squeegee action in successive wiping engagements to clean ink residue from the orifice plate.

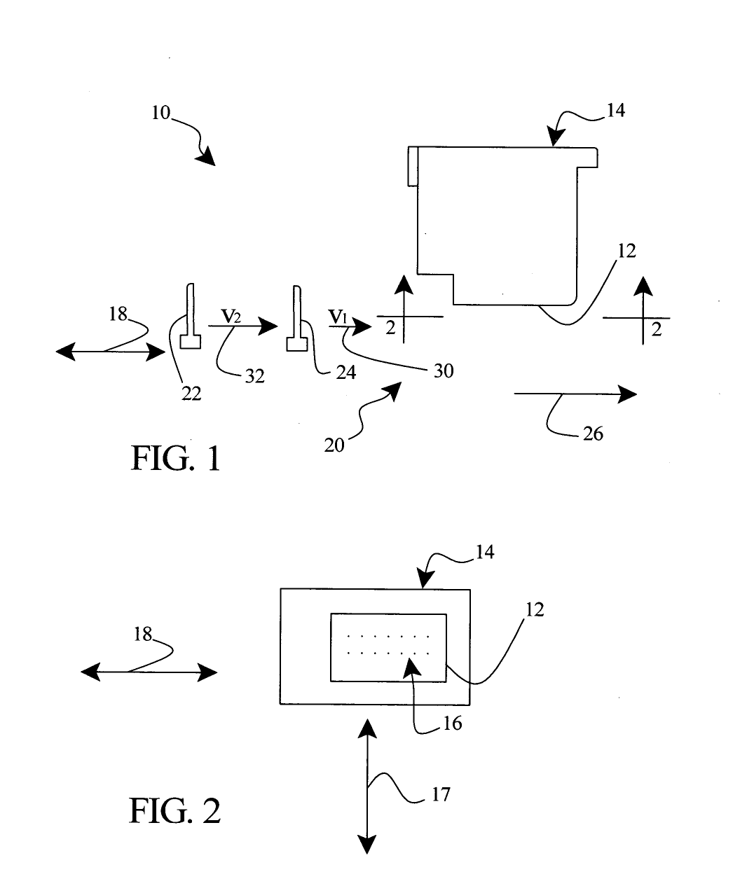

FIG. 1 illustrates schematically and in side view an inkjet orifice plate cleaning system 10 operating to wipe clean an orifice plate 12 of an inkjet cartridge 14. FIG. 2, as taken along lines 2-2 of FIG. 1, illustrates schematically a face view of orifice plate 12 and alignment of an orifice array 16 along an orifice row axis 18.

Generally, orifice array 16 includes a plurality of ink-ejecting orifices following an elongate row-like pattern aligning generally parallel with axis 18. As incorporated into an inkjet printing device (not fully illustrated), cartridge 14 moves relative to media (not shown) and ejects ink droplets from orifice array 16. A variety of mechanical arrangements accomplish such relative movement. Cartridge 14 may move relative to stationary media during printing. Alternatively, media may move relative to a stationary cartridge 14 during printing. A combination of relative movement can also be used to accomplish inkjet printing. Typically, media moves through a print zone associated with cartridge 14 and printing, e.g., ejection of ink droplets onto media, occurs in the print zone.

In one arrangement, media advances along a path generally parallel to axis 18 while cartridge 14 reciprocates through the print zone along a print scan axis 17 (FIG. 2) generally orthogonal to axis 18. It will be understood, however, that embodiments may be implemented in a variety of printing systems without restriction to a particular form of relative movement between cartridge 14 and media receiving print imaging by ink deposition thereon.

Use of cartridge 14 to produce print imaging can accumulate ink and ink residue in and around orifice array 16. For example, some ink droplets or portions thereof may cling to and remain on orifice plate 12 in the vicinity of orifice array 16. Such residue can affect print image quality for subsequent printing operations making use of orifices 16 to eject ink droplets, especially when such residue has opportunity to dry in and around orifices 16.

Thus, occasional cleaning of orifice plate 12 removes ink residue remaining from previous printing operations and improves subsequent printing operations. In one embodiment, cartridge 14 moves along its print scan axis 16 to a cleaning area adjacent the print zone. In the cleaning area, an inkjet orifice plate cleaning system having one or more wipers engages orifice plate 12 in a wiping action to remove ink residue therefrom.

The example inkjet orifice plate cleaning system finds improvement in speed differentiation between a leading wiper speed relative to an inkjet orifice plate and a trailing wiper speed relative to the orifice plate. Wicking action improves at given speed and squeegee action improves at a relatively faster speed. By operating the leading wiper at a given wicking action speed and the trailing wiper at a relatively faster squeegee action speed, improved orifice plate cleaning results.

In system 10, a wiper pair 20 includes wiper 22 and wiper 24. Each of wipers 22 and 24 move relative to and engage orifice plate 12 and thereby clean orifice plate 12, especially in the vicinity of orifice array 16. For the present discussion, cartridge 14 remains stationary with respect to its normal scanning or reciprocating movement while wiper pair 20 moves relative to cartridge 14 along a path generally parallel to axis 18 and in a direction generally orthogonal to the cartridge 14 print scan axis 16. It will be understood, however, that a broad variety of inkjet printing devices may incorporate embodiments of the present invention without such particular relationship between cartridge 14 and wiper pair 20.

Wipers, e.g. wipers 22 and 24, contact orifice plate 12 in wiping engagement including a slight bending in the resilient wiper structure as it bears against and slides along the surface of orifice plate 12. In some embodiments, each wiper is a resilient planar structure mounted to a wiper carriage or transport mechanism moving past the orifice plate. The distal edge of the wiper engages orifice plate 12. The distal edge lies generally transverse to the line of relative movement between a wiper and the orifice plate 12. The size of each wiper, especially the distance between proximal and distal edges, path of movement relative to orifice plate 12, resiliency, and proximity to orifice plate 12 are considered in providing a desired wiping engagement. For example, the distal edge typically extends above a plane containing the orifice plate and the wiper bends as it engages the orifice plate in a wiping movement therepast. For the present discussion, however, wipers are illustrated schematically. Other wiper structures can be used including more rigid spring-biased wipers engaging an orifice plate generally as described for embodiments illustrated herein. It will be understood that in a particular implementation a variety of design parameters and wiper structures are chosen to establish a particular wiping engagement. Accordingly, the present invention shall not be limited to a particular form of wiper shown herein.

Various structures and materials are available to construct and form wipers 22 and 24 to suitably serve as a wicking action wiper and squeegee action wiper, respectively. Generally, wipers as described herein are planar and resilient structures including particular shapes found at the distal edge thereof. For example, a rounded distal edge is useful for wicking action and a sharper or “squared” edge is useful for squeegee action. The particular shapes used in various wipers shown herein generally follow a rounded edge serving a wicking function and a sharper or “squared” edge providing a squeegee action. It will be understood, however, that a variety of shapes and materials may be used to accomplish wicking and squeegee action in a wiper applied to the orifice plate of an inkjet cartridge.

In FIG. 1, wiper pair 20 moves in direction 26 generally parallel to axis 18. As wiper pair 20 approaches orifice plate 12 along direction 26, wiper 24 serves a leading wiper role and wiper 22 serves a trailing wiper role. Wiper 24 moves at speed 30 along direction 26 and relative to orifice plate 12. Wiper 22 moves at speed 32 along direction 26 and relative to orifice plate 12. Wiper 24, as a leading wiper, provides a wicking action relative to orifice plate 12. Wiper 22, as a trailing wiper, provides a squeegee action relative to orifice plate 12.

Speed 30 exceeds speed 32. Cleaning system 10 cleans orifice plate 12 with wiper 24 providing wicking action and with wiper 22 providing squeegee action. Accordingly, wicking action of wiper 24 occurs at a relatively slower speed than squeegee action of wiper 22. System 10 can reposition wiper pair 20 between successive wiping movements to again approach orifice plate 12 along direction 26. Improved cleaning of orifice plate 12 may result in some applications.

Thus, speed variation for wipers with different wiping actions in a wiper pair improves inkjet printer operation in some applications. A first speed for a first wiper having a first wiping action and a second speed for a second wiper having a second wiping action with successive first wiper and second wiper engagements across an inkjet orifice plate improves inkjet printer operation in some applications.

An inkjet orifice plate cleaning system can provide reversible roles for wipers, e.g., bi-functional wipers, in a wiper pair and thereby provide bi-directional wiping. Each distal edge of each wiper has a first side and a second side with the first side providing a wicking action and the second side providing a squeegee action. For relative movement of the wiper pair and the orifice plate in a first direction, one of the wipers serves the leading wiper role and the other wiper serves the trailing wiper role. In an opposite direction, however, wiper roles reverse. When relative movement between the wiper pair and the orifice plate occurs in an opposite or return direction, the previous “leading” wiper becomes the trailing wiper and the previous “trailing” wiper becomes the leading wiper.

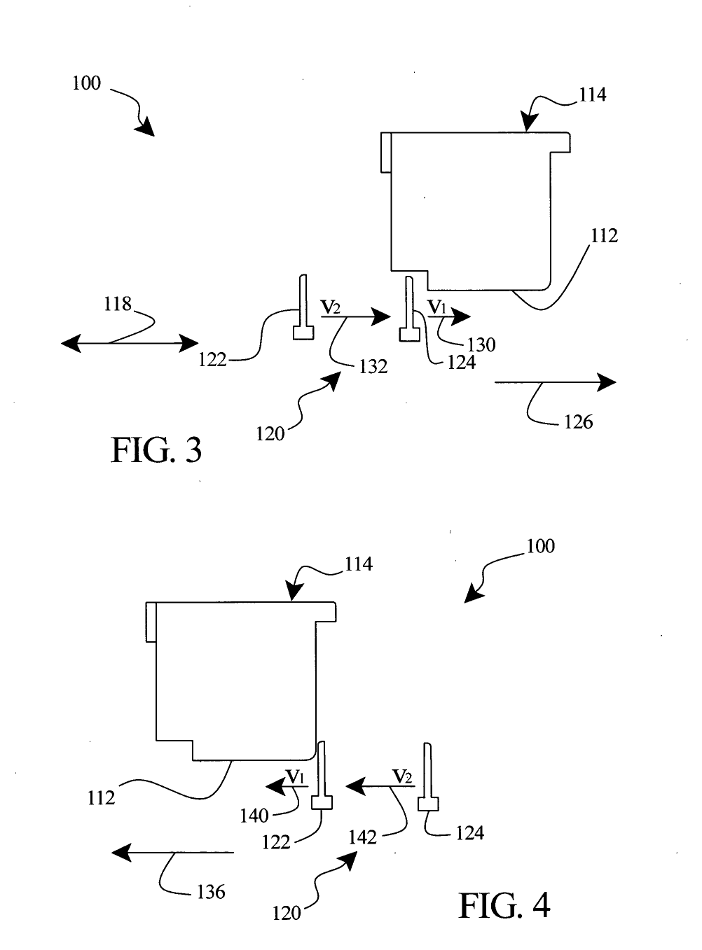

FIGS. 3 and 4 illustrate a second cleaning system 100 having a wiper pair 120 engaging an inkjet orifice plate 112 bi-directionally with leading and trailing members of wiper pair 120 traveling at different speeds relative to the orifice plate 112. In a first direction 126 (FIG. 3) wiper 124 leads and wiper 122 trails. In a return direction 136 (FIG. 4) wiper 122 leads and wiper 124 trails.

Wipers 122 and 124 each provide both wicking and squeegee action depending on the direction of movement relative to orifice plate 112. As viewed in FIGS. 3 and 4, for example, the right side of wiper 124 performs a wicking action and the left side of wiper 124 provides a squeegee action. The right side of wiper 122 performs a squeegee action and the left side of wiper 122 performs a wicking action.

In FIG. 3, wipers 124 and 122 move in direction 126 relative to orifice plate 112 and provide wicking and squeegee action, respectively. In direction 136, wiper 122 assumes a leading position providing wicking action and wiper 124 assumes a trailing position providing squeegee action. As wiper pair 120 moves in direction 126, leading wiper 124 moves relative to orifice plate 112 at speed 130 and trailing wiper 122 moves relative to orifice plate 112 at speed 132. As wiper pair 120 moves in direction 136, leading wiper 122 moves relative to orifice plate 112 at speed 140 and trailing wiper 124 moves relative to orifice plate 112 at speed 142.

Speed 132 exceeds speed 130 and speed 142 exceeds speed 140. Accordingly, when moving in either direction 136 or in direction 126, wiper pair 120 accomplishes wicking action at a relatively slower speed than squeegee action.

A broad variety of mechanical arrangements can provide the described movement of a wiper pair according to systems 10 and 100. It will be understood, therefore, that the following mechanical arrangements are but examples of such variety of mechanical arrangements.

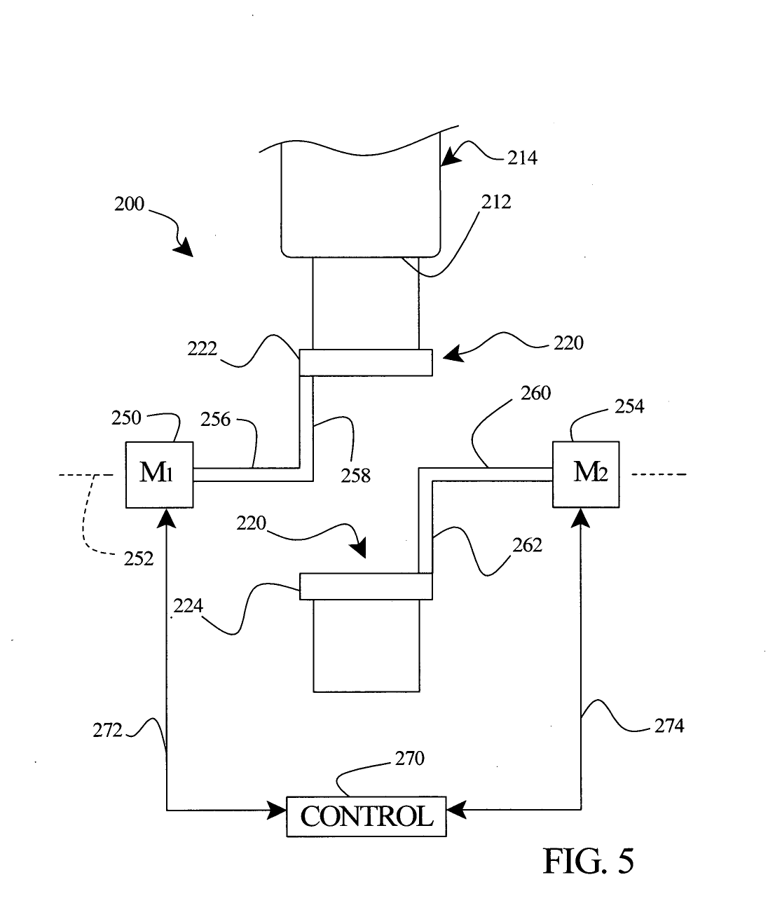

FIGS. 5-7 illustrate schematically a cleaning system 200 operating generally in the fashion of system 100. In FIGS. 5-7, wiper 222 mechanically couples to a motor 250 and rotates about an axis of rotation 252. Wiper 224 mechanically couples to a motor 254 and also rotates about axis of rotation 252. For example, an axle 256 extends from motor 250 along axis 252 and carries an arm 258 carrying wiper 222 at its distal end. Similarly, an axle 260 extends from motor 254 along axis 252 and carries an arm 262 carrying wiper 224. The length of arm 258 and wiper 222 coincides with the length of arm 262 and wiper 224. The distal edges of wipers 222 and 224 thereby coincide at a common radius relative to axis 252.

Wipers 222 and 224 move in circular or angular motion about axis 252 and thereby contact in wiping engagement orifice plate 212 of inkjet cartridge 214. Due to such movement of wipers 222 and 224, the distance from the distal edges of wipers 222 and 224 to axis 252, the length and resiliency of each wiper 222 and 224, and the distance along orifice plate 212 to be wiped are considered in establishing suitable mechanical arrangement for wiping engagement at orifice plate 212.

A control 270 couples at interface 272 to motor 250 and at interface 274 to motor 254. Interface 272 delivers to control 270 positional information identifying a current location for wiper 222. Similarly, interface 274 delivers to control 270 positional information for wiper 224. Control 270 delivers by way of interface 272 drive signals for rotating motor 250 in first and second rotational directions at selected rotational speed. Control 270 delivers by way of interface 274 drive signals for moving motor 254 in selected first and second rotational directions and at a selected rotational speed.

Thus, control 270 possesses positional information for wipers 222 and 224 and can selectively move wipers 222 and 224 in first and second rotational directions each at selected speed of rotation.

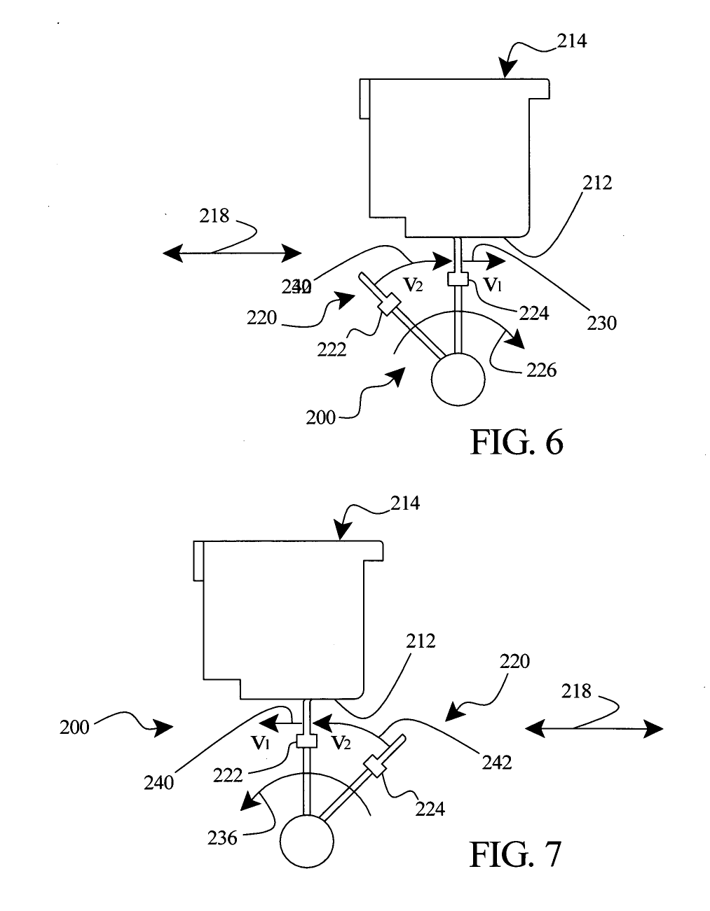

In FIG. 6, cleaning system 200 moves wiper 224 in a first rotational direction 226 at a first rotational speed 230. Wiper 222 follows in the same rotational direction 226, but at a second rotational speed 232. In FIG. 7, wiper 222 moves in a second rotational direction 236 at speed 240 with wiper 224 following in the same rotational direction 236, but at speed 242. As viewed in FIGS. 6 and 7, the right side of wiper 224 and left side of wiper 222 provide a wicking action. The left side of wiper 224 and right side of wiper 222 provide a squeegee action. Thus, wiper pair 220 of system 200 provides wicking action at a first speed and squeegee action at a second, greater, speed. Improved cleaning of orifice plate 212 results.

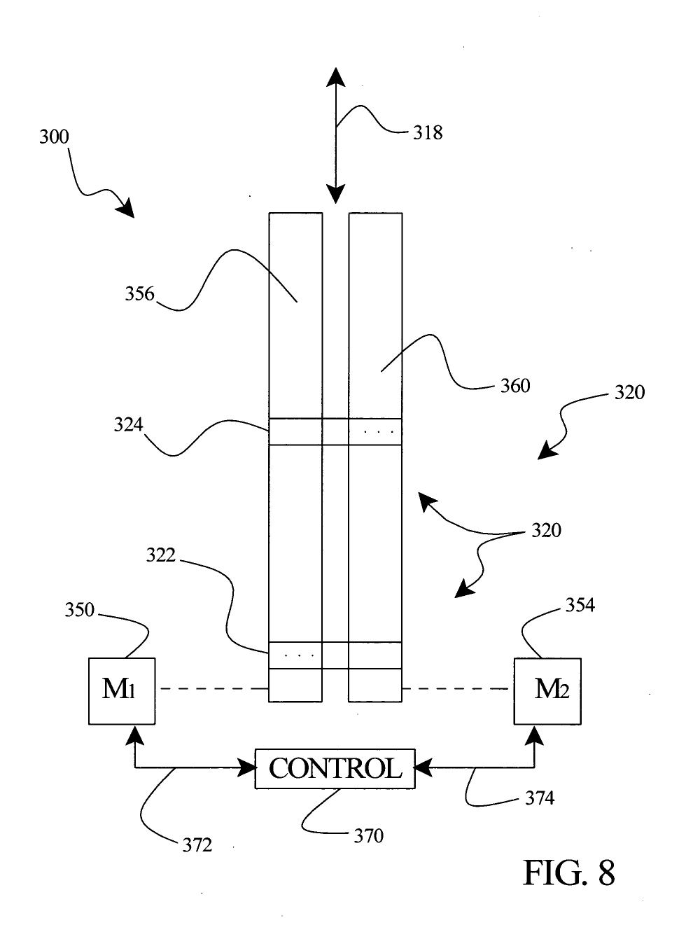

FIGS. 8-10 illustrate a cleaning system 300 providing rectilinear motion for a wiper pair 320. The wipers travel along a path substantially parallel to the surface of the orifice plate and thereby uniformly and consistently engage the orifice plate.

System 300 cleans orifice plate 312 of inkjet cartridge 314. Wiper pair 320 includes wiper 322 and 324. A rack 356 carries wiper 322 and a rack 360 carries wiper 324. Motor 350 drives rack 356 and motor 354 drives rack 360. As seen in FIG. 8, wipers 322 and 324 mount in laterally-extending cantilever fashion relative to racks 356 and 360, respectively, whereby wipers 322 and 324 move along a common travel path 318. A control 370 couples at interface 372 and interface 374 with motors 350 and 354, respectively. Control 370 detects by way of interface 372 and interface 374 a position for each of wipers 322 and 324, respectively. Similarly, control 370 drives by way of interface 372 and 374 a direction and speed of rotation for motors 350 and 354. In this manner, control 370 both positions and selectively moves wipers 322 and 324 in selected directions and speeds along path 318. In some embodiments, the controls 270, 370 each include computer readable media having program instructions for performing the methods described herein.

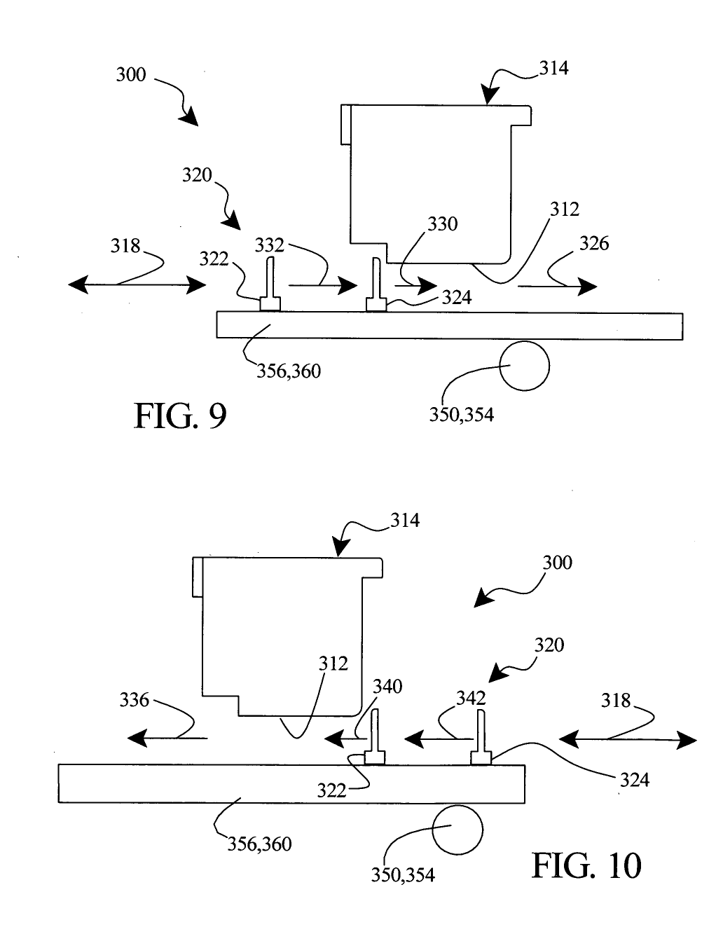

In FIG. 9, control 370 moves wipers 322 and 324 in direction 326 past orifice plate 312 of inkjet cartridge 314. Wiper 324 takes a leading position and wiper 322 a trailing position. Wiper 324 travels at a speed 330 and wiper 322 travels at a relatively greater speed 332. When traveling in direction 326, wiper 324 provides a wicking action and wiper 322 provides a squeegee action.

In FIG. 10, control 370 moves wipers 322 and 324 along path 318 in direction 336. Wiper 322 assumes a leading position and provides wicking action while wiper 324 assumes a trailing position and provides squeegee action. When traveling in direction 336, wiper 322 provides a leading wicking action and wiper 324 provides a trailing squeegee action. In direction 336, wiper 322 travels a speed 340 and wiper 324 travels at a relatively greater speed 342.

Thus, wiper pair 320 of system 300 provides wicking action at a first speed and squeegee action at a second, greater, speed. Improved cleaning of orifice plate 312 results.

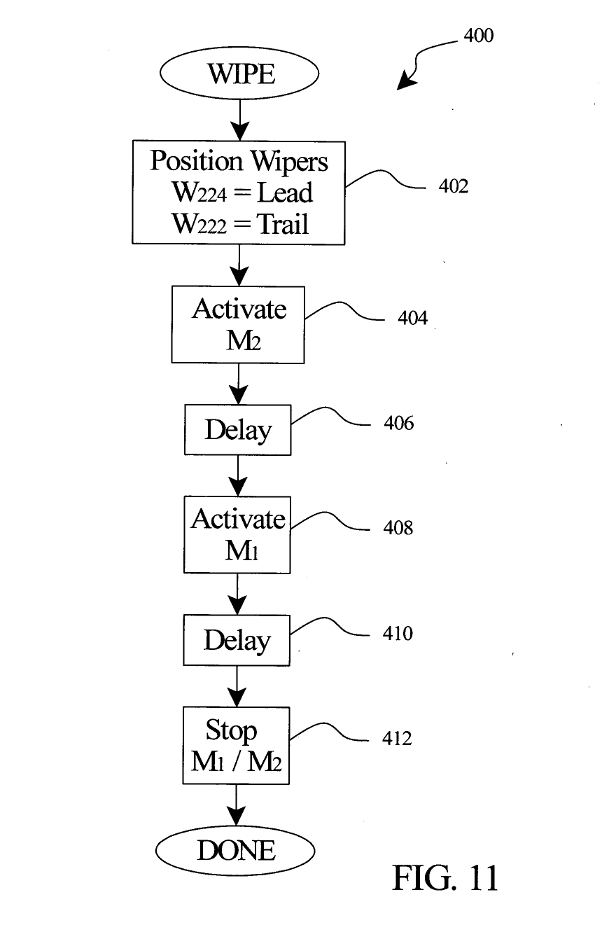

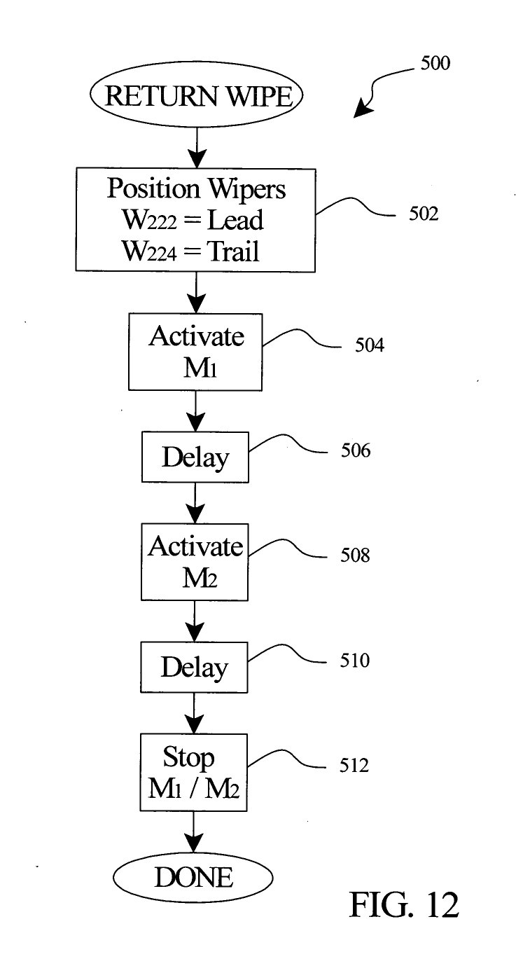

FIGS. 11 and 12 illustrate a control algorithm applicable to controls 270 and 370 for systems 200 and 300 as described herein above. FIG. 11 illustrates a wipe procedure 400 similar to that described for movement of wiper pair 220 in rotational direction 226 and for wiper pair 320 in direction 326. FIG. 12 illustrates a wipe procedure 500 applicable to wiper pair 220 moving in rotational direction 236 and wiper pair 320 moving in direction 336. The algorithms of FIGS. 11 and 12 may also apply to systems 10 and 100 depending on a particular implementation thereof.

For purposes of description, FIGS. 11 and 12 will be described with reference to system 200 but it will be understood that the control scheme illustrated in FIGS. 11 and 12 may be applied to system 300 and to other embodiments described herein.

In FIG. 11 wipe procedure 400 begins in block 402 where control 270 verifies the position for wipers 222 and 224. More particularly, wiper 224 is positioned in the leading role and wiper 222 is positioned in the trailing role. Once so positioned, processing advances to block 404 where control 270 activates motor 254 to move wiper 224 in rotational direction 226 at a selected speed 230. Processing advances to delay block 406 allowing the relatively slower wiper 224 to advance sufficient distance to clear the way for the relatively faster moving trailing wiper 222. In block 408, control 270 activates motor 250 for rotation in direction 226 at speed 240. Wiper 222 thereby follows wiper 224 in engagement of orifice plate 212. Processing then continues to block 410 where sufficient time passes to allow both wipers 224 and 222 to suitably engage and, thereafter, clear contact with orifice plate 212.

The spacing between and relative speed of wipers 222 and 224 may be coordinated to avoid collisions therebetween when executing a wiping action as described herein. Use of delay blocks 406 and 410 in coordination with appropriate positioning of wipers 222 and 224 accomplishes such collision avoidance. In block 412, after wipers 224 and 222 have passed by orifice plate 212, control 270 stops motors 250 and 254.

This completes the wipe procedure 400 and leaves wipers 222 and 224 at an opposite side of cartridge 214 along path 218. In other words, control 270 leaves wipers 222 and 224 in position for return movement in direction 236.

FIG. 12 illustrates return movement of wipers 222 and 224 along direction 236. In FIG. 12, wipe procedure 500 begins in block 502 where control 270 verifies the position of wipers 222 and 224 in the leading and trailing positions, respectively. As may be appreciated, the terminal condition provided by procedure 400 may correspond to the target position indicated in block 502 of procedure 500. With wiper 222 positioned as a lead wiper and wiper 224 positioned as a trailing wiper, control 270 activates motor 250 in rotational direction 236 at speed 240. Wiper 222 then moves toward and engages orifice plate 212 of cartridge 214. Delay block 506 allows sufficient time for the relatively slower moving wiper 222 to advance and provide space along path 218 for the relatively faster moving wiper 224. In block 508, control 270 activates motor 254 and drives wiper 224 in rotational direction 236 at speed 242. Delay 510 permits sufficient time for wipers 222 and 224 to engage and clear orifice plate 212 of cartridge 214. Following delay 510, control 270 stops motors 250 and 254 in block 512.

As may be appreciated, the terminal condition achieved in block 512 of procedure 500 can correspond to the initial target condition indicated in block 402 of procedure 400. In this manner, procedures 400 and 500 operate alternately and iteratively as necessary to wipe clean orifice plate 212 of cartridge 214.

Wicking action can occur at approximately 1.5 inches per second and squeegee action at approximately 3.0 inches per second. Other relative speeds and arrangements can be used depending on the particular implementation.

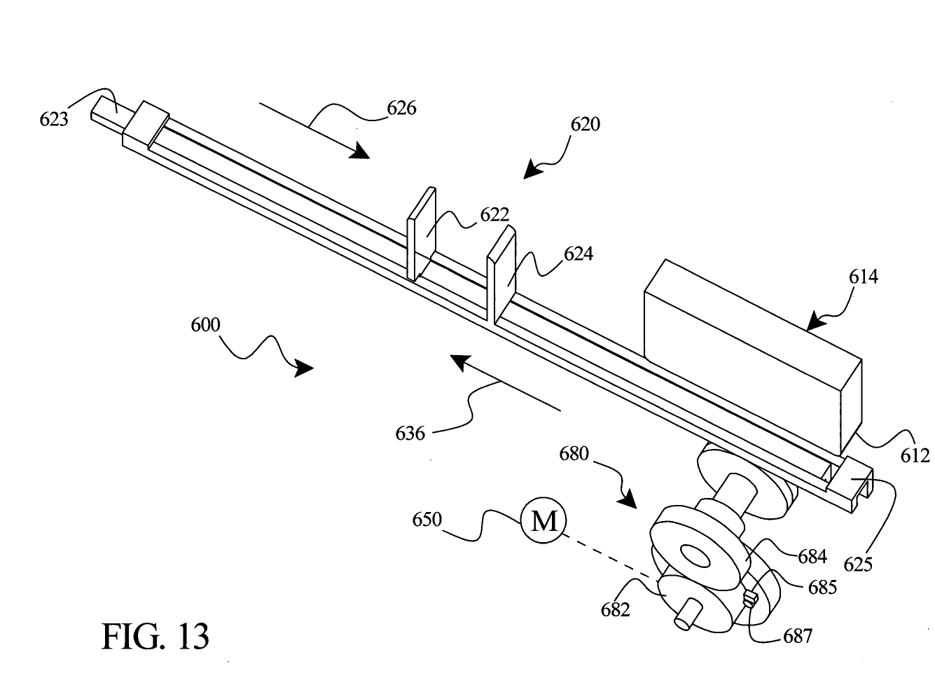

FIGS. 13-16 illustrate an orifice plate cleaning system 600. Orifice plate cleaning system 600 includes a wiper pair 620, including wiper 622 and wiper 624. System 600 engages inkjet cartridge 614 at its orifice plate 612 by drawing wiper pair 620 thereacross.

Wipers 622 and 624 move along a common path in directions 626 and 636. Rack 623 carries wiper 622 and rack 625 carries wiper 624. A motor 650 couples mechanically to a transmission 680 and moves racks 623 and 625 bi-directionally, i.e., in directions 626 and 636, during cleaning operations.

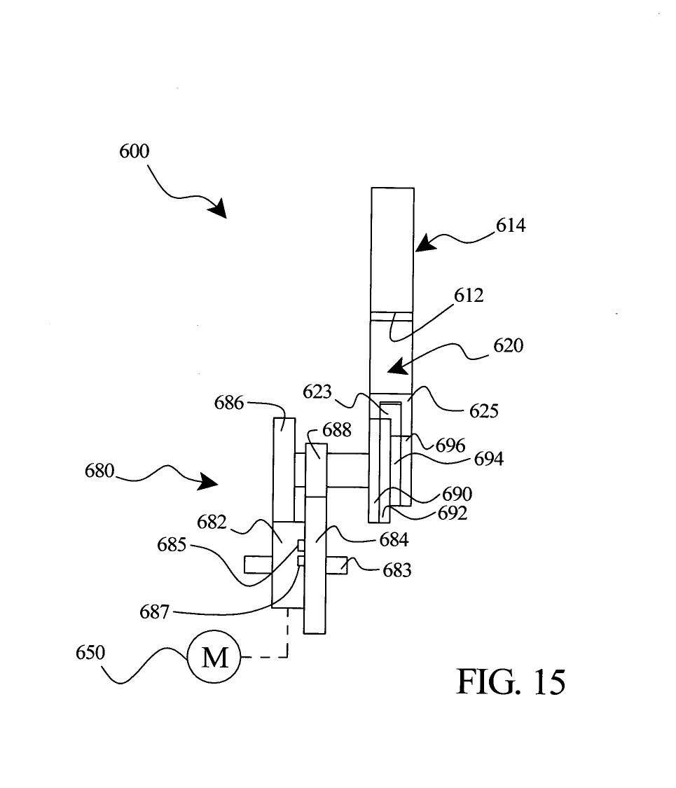

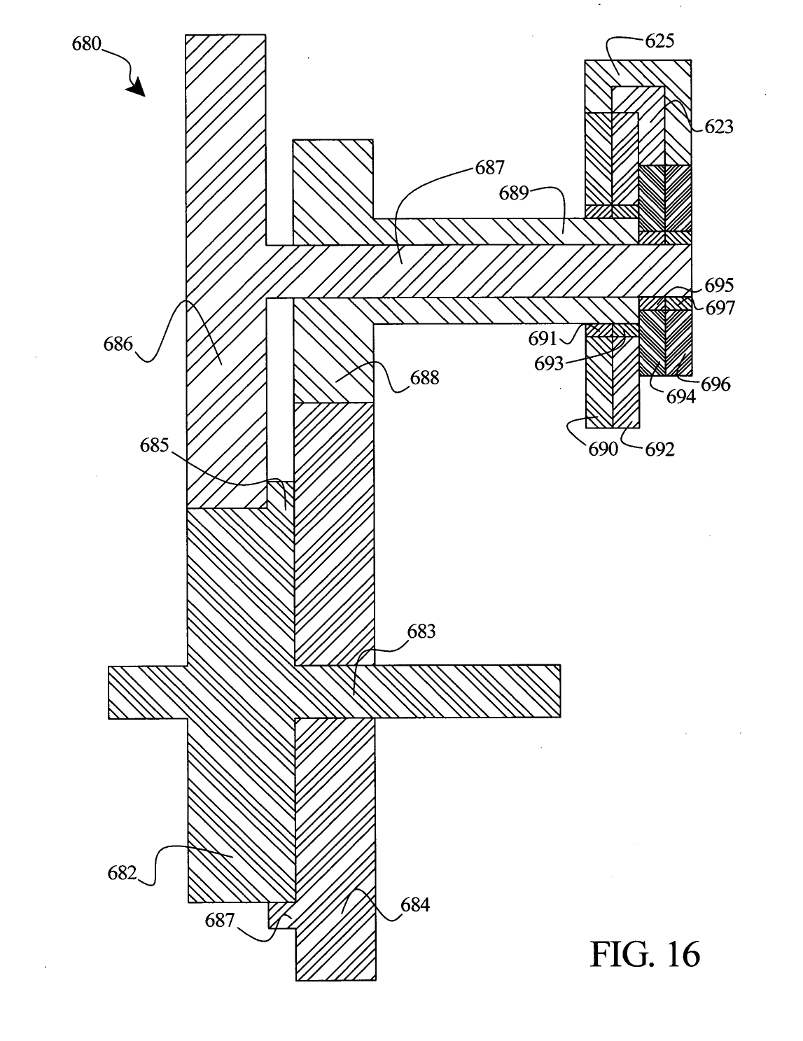

As best seen in FIGS. 15 and 16, transmission 680 includes an input gear 682. Transmission 680 including its various gears as described herein will be illustrated schematically. It will be understood, however, that each gear carries about its outer periphery a set of teeth engaging corresponding teeth of an associated gear as described. Motor 650 couples to gear 682 and thereby drives transmission 680 as described more fully hereafter. For example, a spur gear (not shown) on an output shaft of motor 650 can engage the outer periphery of gear 682. Gear 682 carries coaxially an axle 683. Gear 684 mounts rotationally and coaxially relative to axle 683. Gear 682 carries at its periphery a drive block 685. Gear 684 carries a driven block 687. In FIGS. 13-15, blocks 685 and 687 are positioned for operation beginning with wiper pair 620 positioned as illustrated. In FIG. 16, blocks 685 and 687 are repositioned for better illustration in the cross-sectional view of FIG. 16.

Blocks 685 and 687 move in a common annular path. As a result, rotation of gear 682 in either rotational direction eventually brings drive block 685 into engagement with driven block 687. Accordingly, by suitably initially positioning blocks 685 and 687, gear 682 may be driven approximately one full rotation before block 685 engages block 687 and thereby drives gear 684 into rotation. In other words, rotation of gear 684 may be delayed relative to the onset of rotation for gear 682.

Gear 682 couples at its periphery to the periphery of gear 686. Gear 684 engages at its periphery a gear 688. Thus, rotation of gear 688 is delayed relative to rotation of gear 686 by virtue of coupling to gears 684 and 682, respectively. Gear 686 carries an inner shaft 687 and gear 688 carries an outer shaft 689. Shafts 687 and 689 mount concentrically.

Inner shaft 687 carries at its distal end rack drive gears 694 and 696. A one-way clutch 695 couples gear 694 to shaft 687. One-way clutch 697 couples gear 696 to shaft 687. One-way clutch 695 drives counter clockwise rotation of gear 694 and one-way clutch 697 drives clockwise rotation of gear 696. In this manner, one of gears 694 and 696 operate depending on the direction of movement for inner shaft 687. When inner shaft 687 moves in a clockwise direction, gear 694 remains stationary and gear 696 moves along with shaft 687 in a clockwise direction. When shaft 687 moves in a counter clockwise direction, gear 696 remains stationary and gear 694 moves counter clockwise. Gear 694 couples to rack 623 and gear 696 couples to rack 625. Accordingly, clockwise rotation of shaft 687 causes movement of rack 625 and wiper 624 in direction 626 and counter clockwise rotation of shaft 687 moves rack 623 and wiper 622 in direction 636.

Gears 690 and 692 couple to the distal end of outer shaft 689. A one-way clutch 691 couples shaft 689 and gear 690 while a one-way clutch 693 couples shaft 689 and gear 692. Clutch 693 drives clockwise rotation of gear 692 while clutch 691 drives counter clockwise rotation of gear 690. In this manner, one of gear 690 and 692 operates in response to rotation of shaft 689. When shaft 689 rotates in a clockwise direction, gear 692 follows and moves rack 623 and wiper 622 in direction 626. When shaft 689 moves in a counter clockwise direction, gear 690 follows and drives rack 625 and wiper 624 in direction 626.

Speed variation between wipers 622 and 624 is accomplished by virtue of selected gearing within transmission 680. Rack 625 moves faster than rack 623 when driven by outer shaft 689 and rack 623 moves faster than rack 625 when driven by outer shaft 689. Generally, movement caused by gear train 682, 686, and one of gears 694 and 696 is leading and relatively low speed movement. Movement caused by gear train 684, 688, and one of gears 690 and 692 is trailing and relatively high speed movement. Thus, one of racks 623 and 624 moves at relatively low speed at the onset of motor 650 activation and the other one of racks 623 and 623 follows with delay and at relatively higher speed.

In operation, taking system 600 in its configuration as illustrated in FIG. 13, motor 650 first drives gear 682 in a counter clockwise direction. This begins immediate rotation of gear 686 in a clockwise direction with, by virtue of one-way clutch 697, clockwise rotation of gear 696. This results in slow speed movement of rack 625 and wiper 624 in direction 626 toward cartridge 614.

Eventually, drive block 685 engages driven block 687 and brings gear 684 into counter clockwise rotation. This in turn drives gear 688 into clockwise rotation and, by virtue of one way clutch 693, drives gear 692 into clockwise rotation. Clockwise rotation of gear 692 brings rack 623 and its wiper 622 into high-speed movement in direction 626 towards cartridge 614.

Wipers 624 and 622 suitably engage and pass by orifice plate 612. At this point, motor 650 stops. This completes a wiping engagement. System 600 is prepared for a next wiping engagement by reversing motor 650. In such case, motor 650 moves gear 682 in a clockwise direction. Clockwise movement of gear 682 causes counter clockwise movement of gear 686 and, therefore, movement of rack 623 and wiper 622 in the return direction 636 via shaft 687 and gear 694. Eventually, block 685 engages block 687 and drives gear 684 into clockwise rotation which brings gear 688 into counter clockwise direction. Counter clockwise direction of gear 688 causes corresponding counter clockwise movement of gear 690 and, therefore, high speed movement of rack 625 and wiper 624 in return direction 636.

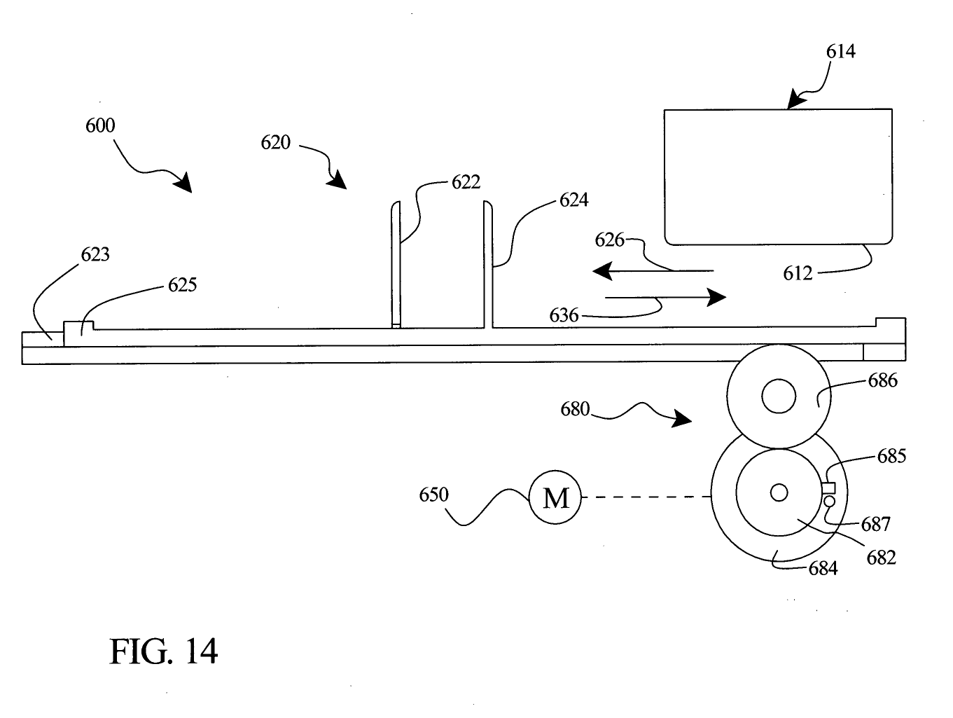

Wipers 622 and 624 thereby move at different speeds. Whenever wiper 624 leads, it moves at a relatively slower speed with a delay provided before onset of the relatively faster wiper 622. Similarly, when wiper 622 leads it moves at a relatively slower speed with a delay provided before onset of the relatively faster moving wiper 624. As in earlier embodiments, each of wipers 622 and 624 are bi-functional. In other words, and in the view of FIG. 14, the distal edge of each wiper 622 and 624 includes structures for both wicking and squeegee action. The right and left sides of wipers 624 and 622, respectively, are shaped in rounded fashion to provide wicking action. The left and right sides of wipers 624 and 622, respectively, are sharp or “squared” to provide squeegee action. Thus, when wiper 624 leads, it provides wicking action and wiper 622 provides squeegee action. When wiper 622 leads, it provides wicking action and wiper 624 provides squeegee action.

It will be appreciated that a motor, e.g., motor 650, applied to transmission 680 need only provide bi-directional rotation at a fixed rotational speed. Accordingly, a simplified control and reduced cost of manufacture results.

Thus, improved orifice plate cleaning has been shown. Differentiation in speed for wicking action versus squeegee action improves orifice plate cleaning.

It will be appreciated that the present invention is not restricted to the particular embodiments that have been described and illustrated, and that variations may be made therein without departing from the scope of the invention as found in the appended claims and equivalents thereof.

1. A method of cleaning an orifice plate, the method comprising:
moving a first wiper relative to said orifice plate at a first speed and engaging said orifice plate with said first wiper to accomplish a first cleaning function therewith; and
moving a second wiper relative to said orifice plate at a second speed and engaging said orifice plate with said first wiper to accomplish a second cleaning function therewith.

2. A method according to claim 1 wherein said first wiper and said second wiper engage said orifice plate consecutively.

3. A method according to claim 1 wherein said first speed is slower than said second speed.

4. A method according to claim 1 wherein said first cleaning function is a wicking function and said second cleaning function is a squeegee function.

5. A method according to claim 1 wherein said first wiper and said second wiper comprise a wiper pair, said wiper pair moving in a given direction relative to said orifice plate during said contact with said orifice plate.

6. A method according to claim 5 wherein said steps of claims 1 repeat in a second given direction, said second given direction being opposite said first given direction.

7. A method according to claim 1 wherein said first wiper and said second wiper each are bi-functional wipers, said first wiper moving in a first direction and said second wiper moving in a second direction to provide wicking action.

8. A method according to claim 7 wherein said first wiper moves in said second direction and said second wiper moves in said first direction to provide squeegee action.

9. A method according to claim 1 wherein at least one of said moving said first wiper and moving said second wiper includes linear movement.

10. A method according to claim 1 wherein at least one of said moving said first wiper and moving said second wiper includes angular movement.

11. A method of cleaning an orifice plate in an inkjet printer:
contacting said orifice plate with a leading one of first and second wipers; and
thereafter contacting said orifice plate with a trailing one of said first and second wipers, said leading one of said first and second wipers moving at a first speed and said trailing one of said first and second wipers moving at a second speed, the first speed and the second speed being different.

12. A method according to claim 11 wherein said first speed is slower than said second speed.

13. A method according to claim 11 wherein said first wiper moving in a first direction provides a wicking action relative to the orifice plate and said second wiper moving in said first direction provides a squeegee action relative to said orifice plate.

14. A method according to claim 13 wherein said first wiper moving in a second direction provides a squeegee action relative to the orifice plate and said second wiper moving in said second direction provides a wicking action relative to said orifice plate.

15. A method according to claim 11 wherein at least one of said first wiper and said second wiper moves linearly.

16. A method according to claim 11 wherein at least one of said first wiper and said second wiper moves angularly.

17. A method of wiping an inkjet orifice plate, the method comprising the steps:
providing a wiper, said wiper having a distal edge, said edge having a first side adapted for a first wiping action and having a second side adapted for a second wiping action;
engaging the orifice plate at said first edge of said wiper while moving in a first direction and at a first speed; and
engaging the orifice plate at said second edge of said wiper while moving in a second direction and at a second speed, said second speed being different than said first speed.

18. A method according to claim 17 wherein said wiper is a resilient planar structure.

19. A method according to claim 17 wherein said first wiping action is a wicking action.

20. A method according to claim 17 wherein said second wiping action is a squeegee action.

21. A method according to claim 17 wherein at least one of said first wiper and said second wiper moves linearly.

22. A method according to claim 17 wherein at least one of said first wiper and said second wiper moves angularly.

23. An inkjet orifice plate cleaning system comprising:
a wiper pair, a first member of said wiper pair providing a wicking action in a first direction and a second member of said wiper pair providing a squeegee action in said first direction; and
means for moving said first member of said wiper pair in said first direction at a first speed and for moving said second member of said wiper pair in said first direction at a second speed, the first speed being different from the second speed.

24. A system according to claim 23 wherein said first speed is less than said second speed.

25. A system according to claim 23 wherein said means for moving comprises:
a first rack carrying said first member of said wiper pair;
a second rack carrying said second member of said wiper pair;
a bi-directional motor; and
a transmission coupling said motor and said first and second racks to selectively move said first and second racks in said first direction, said transmission delaying onset of said second rack movement relative to onset of said first rack movement, said transmission moving said second rack at a greater speed relative to that of said first rack.

26. A system according to claim 25 wherein said transmission comprises a first shaft, said first shaft being coupled to said first rack by a first one-way clutch having a first rotational sense and being coupled to said second rack by a second one-way clutch having a second rotational sense.

27. A system according to claim 26 wherein said first rotational sense and said second rotational sense are opposite.

28. A system according to claim 25 wherein said transmission comprises a second shaft, said second shaft being coupled to said first rack by a first one-way clutch having a first rotational sense and being coupled to said second rack by a second one-way clutch having a second rotational sense.

29. A system according to claim 28 wherein said first rotational sense and said second rotational sense are opposite.

30. A system according to claim 25 wherein said transmission comprises a first shaft and a second shaft, said first shaft being coupled to said first rack by a first one-way clutch having a first rotational sense and being coupled to said second rack by a second one-way clutch having a second rotational sense, said second shaft being coupled to said first rack by a third one-way clutch having said first rotational sense and being coupled to said second rack by a fourth one-way clutch having said second rotational sense.

31. A system according to claim 30 wherein said first rotational sense and said second rotational sense are opposite.

32. A system according to claim 23 wherein said means for moving further comprises moving said first member of said wiper pair in a second direction at a third speed and moving said second member of said wiper pair in said second direction at a fourth speed.

33. A system according to claim 32 wherein said fourth speed is greater than said third speed.

34. A system according to claim 23 wherein said means for moving comprises:
a bi-directional motor;
an input gear mechanically coupled to said motor, said input gear carrying a drive block;
a second gear carrying a driven block, said drive block and said driven block moving in a common annular path whereby activation of said motor drives said first gear to bring said drive block into engagement with said driven block and thereby move said second gear into rotation; and
means coupling said first gear to said first wiper to move said first wiper at said first speed and coupling said second gear to said second wiper to move said second wiper at said second speed.

35. A system according to claim 34 wherein said coupling means comprises a high-speed shaft and a low-speed shaft, said high-speed shaft being coupled to said first rack by a first one-way clutch having a first rotational sense and being coupled to said second rack by a second one-way clutch having a second rotational sense, said low-speed shaft being coupled to said first rack by a third one-way clutch having said first rotational sense and being coupled to said second rack by a fourth one-way clutch having said second rotational sense.

36. A system according to claim 35 wherein said first rotational sense and said second rotational sense are opposite.

37. An inkjet orifice plate cleaning system, comprising:
a first wiper configured to engage the inkjet orifice plate at a first speed; and
a second wiper configured to engage the inkjet orifice plate at a second speed, the first speed being different from the second speed.

38. A system according to claim 37 wherein said first wiper and said second wiper engage said orifice plate consecutively.

39. A system according to claim 37 wherein said first speed is slower than said second speed.

40. A system according to claim 37 wherein said first wiper provides a wicking function and said second wiper provides a squeegee function.

41. A system according to claim 37 wherein said first wiper and said second wiper comprise a wiper pair, said wiper pair moving in a given direction relative to said orifice plate during said contact with said orifice plate.

42. A system according to claim 37 wherein said first wiper and said second wiper each are bi-functional wipers, said first wiper moving in a first direction and said second wiper moving in a second direction to provide wicking action.

43. A system according to claim 42 wherein said first wiper moves in said second direction and said second wiper moves in said first direction to provide squeegee action.

44. A system according to claim 37 wherein at least one of said first wiper and said second wiper moves linearly.

45. A system according to claim 37 wherein at least one of said first wiper and said second wiper moves angularly.
